(19) United States
(12) Patent Application Publication
(10) Pub. No.: US 2025/0307668 A1
(43) Pub. Date: Oct. 2, 2025

(54) REAL-TIME CONTEXTUAL RETRIEVAL AND GENERATION

(71) Applicant: NEC Laboratories America, Inc., Princeton, NJ (US)

(72) Inventors: Murugan Sankaradas, Dayton, NJ (US); Srimat Chakradhar, Manalapan, NJ (US); Ravi Kailasam Rajendran, Colonia, NJ (US)

(21) Appl. No.: 19/089,244

(22) Filed: Mar. 25, 2025

Related U.S. Application Data
(60) Provisional application No. 63/570,874, filed on Mar. 28, 2024.

(51) Int. Cl. G06N 5/025

(52) U.S. Cl. CPC G06N 5/025

(57) ABSTRACT

Methods and systems for query processing include updating a knowledge graph based on information extracted from a streaming information input. One or more queries relating to the streaming information input are processed based on the knowledge graph. An action is performed responsive to the one-or-more queries.

### RELATED APPLICATION INFORMATION

This application claims priority to U.S. Patent Application No. 63/570,874, filed on Mar. 28, 2024, incorporated herein by reference in its entirety.

### BACKGROUND

### Technical Field

The present invention relates to machine learning systems and, more particularly, to retrieval augmented generation.

### Description of the Related Art

Retrieval augmented generation (RAG) can be used to enhance the output of large language models (LLMs) by referencing external knowledge bases before a response is generated. However, RAG may rely on fetching, indexing, and converting static external data into structured formats. This process can be time-consuming, particularly for real-time data streams like videos. In these scenarios, important events such as accidents or anomalies may occur within a span of seconds. If the LLM is augmented with outdated data then there is a risk that key events may be missed and inaccurate descriptions of the real-time stream may be generated. Such systems are therefore unsuitable for real-time applications.

### SUMMARY

A method for query processing includes updating a knowledge graph based on information extracted from a streaming information input. One or more queries relating to the streaming information input are processed based on the knowledge graph. An action is performed responsive to the one-or-more queries.

A system for query processing includes a hardware processor and a memory that stores computer program instructions. When executed by the hardware processor, the computer program instructions cause the hardware processor to update a knowledge graph based on information extracted from a streaming information input, to process one or more queries relating to the streaming information input based on the knowledge graph, and to perform an action responsive to the one-or-more queries.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a query processing system that operates on streaming information using a knowledge graph, in accordance with an embodiment of the present invention;

FIG. 2 is a block/flow diagram that illustrates knowledge extraction that updates a knowledge graph in real-time based on streaming input, in accordance with an embodiment of the present invention;

FIG. 3 is a block/flow diagram of a method for monitoring and responding to streaming information using a knowledge graph, in accordance with an embodiment of the present invention;

FIG. 4 is a block diagram of a computing device that can perform query processing with a knowledge graph, in accordance with an embodiment of the present invention;

FIG. 5 is a diagram of an exemplary neural network architecture that can be used to implement a large language model for processing queries, in accordance with an embodiment of the present invention; and

FIG. 6 is a diagram of an exemplary deep neural network architecture that can be used to implement a large language model for processing queries, in accordance with an embodiment of the present invention.

### DETAILED DESCRIPTION OF PREFERRED EMBODIMENTS

To provide real-time comprehension of streaming information, an efficient, lightweight model may be used to construct an evolving knowledge graph of the streaming content. While extracting all actors and their relationships within the real-time scene's knowledge graph may not be computationally feasible, key aspects may be prioritized for rapid response. Scene-object-entity relationships are extracted in a contextual manner considering system constrains, operational limitations, and the evolving event context. The knowledge graph provides an efficient representation of the scene and facilitates real-time context-aware information retrieval.

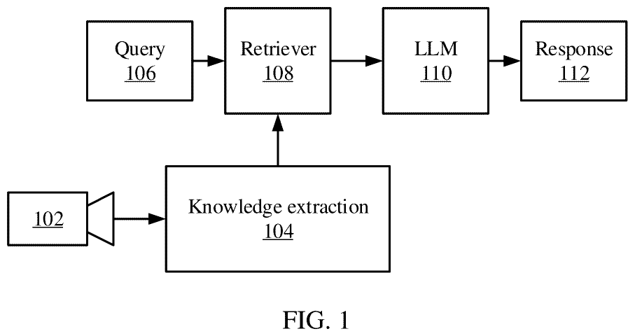

Referring now to FIG. 1, a diagram of a streaming retrieval augmented generation (RAG) system is shown. Streaming information is provided by, e.g., a video camera 102. In this example video information includes a series of image frames that depict a particular scene, which may include various objects and agents. Thus the streaming information may include real-time information about the actions being performed within the scene. In some embodiments the streaming information may include multivariate time series data, for example being generated by a plurality of different sensors, such as Internet of Things sensors in a given facility, where information from the sensors can be used to identify anomalous activity to control the behavior of systems in the facility. In some embodiments the streaming information may include video of a road scene, where information relating to traffic and accidents can be used to control traffic.

Knowledge extraction 104 operates on the streaming information. As will be described in greater detail below, knowledge extraction 104 may use an extraction pipeline and a knowledge pipeline to provide information for standard and interactive queries on both real-time and historical data. The extraction pipeline orchestrates the extraction of metadata, such as spatial information, from frames subject to real-time constraints. The knowledge pipeline discerns real-time context, building responses through a fusion of a context-based static knowledge base and a dynamically evolving knowledge graph. This information is stored in a data store that is accessible to retriever 108.

The retriever 108 is given a query 106 that asks a question about the streaming information. The query 106 may include a standing query that, for example, asks to be notified when a given event occurs. The query 106 may also, or instead, include a dynamic query that asks about the current or historical information provided in the streaming information. The retriever 108 uses the query 106 to fetch information from the data store, for example using a semantic search. The retriever 108 then forwards the retrieved information, along with the query 106, to a large language model (LLM) 110. The LLM 110 generates a response 112 that includes an answer to the query 106. For example, the LLM 110 may generate textual descriptions, may answer questions, and may perform other tasks based on a multi-modal input.

Instead of using a heavy-duty LLM to extract contextual information from the streaming content, temporal context and efficiency are prioritized by the extraction and dynamic knowledge pipelines. Low-level object information and their relationships are extracted by dynamically prioritizing information about specific entity-attribute-relationship knowledge tuples. Embeddings for the incoming stream are created, followed by the construction of a knowledge graph. Contextual accuracy in an evolving scene is maintained using the temporal knowledge graph.

In some cases the response 112 may include an action to enhance traffic flow, safety, and efficiency. The analysis may include extraction of insights from camera video streams to provide real-time detection of anomalies like traffic accidents, road congestion, and pedestrian hazards. Metadata associated with these anomalies can be used to generate detailed context-aware descriptions about the evolving incident, which can improve situational awareness. In some cases the response 112 may include summoning emergency services, sending instructions to self-driving vehicles to avoid a hazard, and sending instructions to traffic control devices such as traffic lights to reroute traffic away from an incident.

In some cases the response 112 may include a response to information collected by satellites. For example, there is a rapid proliferation of satellite constellations, which may have many low-Earth orbit satellites. Drawing streaming information from such satellites provides relatively up-to-date satellite imagery of any location on Earth, which can be used to identify natural disasters and man-made changes. These satellites may generate a large amount of data, so that the rapid analysis provided herein makes it possible to rapidly identify and respond to changing circumstances.

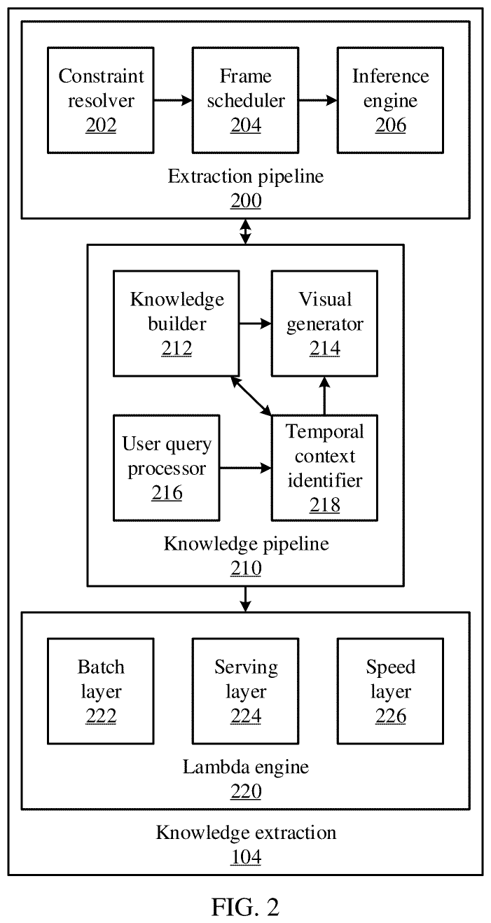

Referring now to FIG. 2, additional detail on knowledge extraction 104 is shown. The knowledge extraction 104 receives real-time streaming information from, e.g., camera 102 or other sensors. Knowledge extraction 104 also receives the query 106 and information relating to constraints.

In some cases the query 106 may include a standing query that asks the system to continuously scan the streaming information for specific updates or conditions. A standing query is distinguished from a one-time query that has a finite response. Standing queries may offer a continual awareness of specific events or patterns within data.

Interactive queries, in contrast to standing queries, are dynamic requests that may involve bidirectional exploration within a data set. Interactive queries allow users to refine their query based on the initial response and to dive deeper into specific aspects to discover hidden patterns or connections within the data. Interactive queries may leverage both real-time data and historical data.

An extraction pipeline 200 orchestrates the extraction of metadata, such as spatial information, from frames using inference engines subject to real-time constraints. While processing every data chunk or frame of the incoming streaming information might be ideal for a thorough analysis, it may be computationally infeasible in real-time. The extraction pipeline 200 therefore prioritizes data selection based on actions or activities under dynamically evolving scenarios. For example, dynamic sub-sampling may be used in a video stream to analyze only a subset of the frames or a specific area of interest within the video based on ongoing events detected in the stream. Different data streams may furthermore have different priorities depending on their importance to a user at different times of day—for example a certain camera 102 may need to be processed at different frame-rates or different resolutions at different times.

A constraint resolver 202 identifies the processing limitations, such as a time limit or a frame-rate target. A frame scheduler 204 balances the need for detailed analysis against these constraints. The complexity of video content may vary from one frame to the next, with some frames showing objects or actors of interest that need detailed analysis, whereas other frames may show only a static scene. Intelligent frame selection or sampling is used so that the important content is selected for analysis.

In the case of video streams, real-time processing begins when a frame arrives at the extraction pipeline 200. Visual language models (VLMs) of different capabilities, such as lightweight and heavyweight variants, may be used in accordance with the level of detail needed. The frame scheduler 204 analyzes incoming frames to assess their content and complexity, considering factors such as motion and scene detail. The frame scheduler 204 selects a frame rate for the computing models.

The frame scheduler 204 may include a frame queue, a frame analysis module, a decision engine, a frame dispatcher, and a feedback loop. The queue holds frames awaiting processing, while the frame analysis module analyzes the frame's complexity. The decision engine uses these analyses to determine a frame rate, and the frame dispatcher orchestrates frame distribution accordingly. The feedback loop monitors actual frame rates and refines future decisions for ongoing optimization. This dynamic approach to frame scheduling ensures smooth performance while adapting to diverse system demands and user constraints.

The constraint resolver 202 can dynamically adjust resource utilization based on content characteristics, system availability, and user-defined constraints. The constraint resolver 202 optimizes dynamic scheduling of frames across VLMs within the extraction pipeline 200. User-specified constraints may include frames per second limits, latency per frame associated with different VLMs, a predefined maximum latency threshold, and the cost of inference. System-level operational constraints may be dynamically determined by tracking available system resources such as CPU usage, GPU load, and memory availability. The constraint solver 202 strikes a balance between computational resources and latency. Throughput is maximized while ensuring that overall latency remains within acceptable bounds.

An inference engine 206 may use a lightweight VLM and a heavyweight VLM to process one or more queries for a given frame image input. The bifurcation provides tiered analysis, catering to different levels of complexity and computational limits. The lightweight VLM may be specifically dedicated to handling questions from a question bank, acting as an initial filter for event detection. The heavyweight VLM may be used to correct and adjust the responses of the lightweight VLM by updating the current context-based questions.

While the extraction pipeline 200 only extracts metadata from the streaming information, the knowledge pipeline 210 builds knowledge based on that extracted metadata. The metadata may be translated into actionable knowledge, enabling the system to answer user queries and provide feedback to the extraction pipeline 200, guiding its metadata extraction. The knowledge pipeline 210 analyzes a current responses, constructs temporal context by leveraging spatial details across frames, monitors events, refines queries for subsequent frames, and recognizes the user query's intent in interactive scenarios.

The knowledge pipeline 210 makes use of a knowledge base, providing an initial context for understanding incoming streaming information. The knowledge base collects, retrieves, organizes, and shares information. The knowledge base may include information that is tailored to particular scenarios. For example, in a traffic monitoring scenario, the knowledge base may include information about actors like pedestrians, drivers, and vehicles, as well as contextual information such as relationships, traffic rules, road infrastructure information, and historical traffic patterns. The knowledge base may also include data on speed limits, traffic signal timing, and common routes. In a healthcare scenario, the knowledge base may include medical guidelines, healthcare facility policies, symptom databases, and information on various health conditions.

A knowledge graph may be represented using semantic tuples, such as a subject-predicate-object tuple. The subject and object represent an entity pair, such as a person and a location, or an object and its property. The predicate specifies the relationship label that connects the entities. The knowledge graph may be a dynamic and evolving representation of relationships and entities within the streaming information, which may be updated in real-time based on the information derived from incoming frames. The knowledge graph acts as a dynamic memory of the system, capturing the nuances and contextual details needed for intelligent processing and response generation.

The information stored in the knowledge graph may be contingent upon the context of the specific use case. Following the example of traffic monitoring, the foundational knowledge from the knowledge base aids in initializing the knowledge graph, which can dynamically adapt to evolving real-time traffic conditions, accidents, and construction activities. In the healthcare example, the knowledge graph evolves with real-time data from monitoring devices and patient records, ensuring a deeper understanding of individual health profiles, recent medical events, and the broader healthcare landscape for informed decision-making and anomaly detection.

A knowledge builder 212 uses the knowledge base and user-directed contexts to construct and continually refine the knowledge graph. This process adapts dynamically to the streaming information, ensuring that the knowledge graph remains current and reflective of real-time events. By interfacing with the knowledge base, the knowledge builder 212 enriches the knowledge graph with insights from both historical and live data sources. Knowledge graph generation from the scene-level spatial understanding is achieved by modeling the probability Pr(G|F)=Pr(B,L,R), where F is an input frame, G is the knowledge graph, bᵢ ∈ B is a bounding box in the frame, L is a set of object labels, and R is a set of relations among the objects L. The probability distribution Pr(G|F) models the likelihood of generating a knowledge graph G given an input frame F. This probability distribution may be modeled based on the joint probability of bounding boxes B, class labels L, and relationships R between the labels in the input frame.

A temporal context identifier 218 is used to generate temporal context for streaming information. The temporal context can trigger the allocation of resources to analyze deeper into an evolving situation. These resources may include increased processing power or higher frame rates from the data stream, allowing for a more detailed understanding of the unfolding events. Resource allocation may be adjusted based on the identified temporal context to ensure that important details are not missed.

Frames undergo an intricate individual processing stage, where rich spatial information is extracted from each frame in the extraction pipeline. The granular spatial data is then combined, offering a comprehensive understanding of the temporal context. The details from individual frames may be combined to gain a temporal perspective.

The extraction of temporal context involves a structured sequence of steps. First the system identifies the user query's specific needs. Second, the relevant records are fetched from the data store. Third, the retrieved content is prioritized through ranking and filtering via moderation. This iterative process of fetching, ranking, and refining continually enhances the accuracy and relevance of the temporal context.

The user query is transformed into a dense vector using an embedding model, ϕ. This dense vector is then used as input to a semantic search, whether symmetric or asymmetric, to identify relevant contexts from the data store. Such considerations may include a number of records to fetch, assessing the effectiveness of the response in capturing the event, and refining prompt construction for subsequent iterations based on the specific use case scenario.

Beyond simple retrieval, identifying context and extracting information from subsequent frames involves querying the knowledge base to identify associated entities and relationships. Entities with the highest probabilities are selected, prompting the construction and subsequent updating of prompts for the next iterations of questions within the VLM inference engine 206 in the extraction pipeline 200.

The knowledge graphs are adaptable, changing based on evolving contexts. This dynamic nature helps the knowledge graph capture real-time alterations. Once an event concludes, or the situation stabilizes, the knowledge graph may be reset to ensure it is aligned with the current state of the scene.

A visual query generator 214 interfaces between the extraction pipeline 200 and the knowledge pipeline 210, incorporating a current response to pull pertinent information from the knowledge graph. Given the current response Sₜ and questions Qₜ, the visual generator 214 interfaces with the knowledge graph through the temporal context identifier 218 at the time t. Query generator 214 integrates Sₜ with the knowledge base at time t, KB^{t}, to update the set of questions Qₜ₊ₖ←VWG(Sₜ,KB^{t}) , where VWG(·,·) indicates the operation of the visual query generator 21. The refined questions q ∈ Qₜ₊ₖ for subsequent frames ƒₜ₊ₖ are embedded into the current prompt, denoted as P, which is dispatched to the extraction pipeline 200 for subsequent frame spatial information extraction.

A user query processor 216 connects user interactions to the underlying system, translating user queries into actionable executors for the real-time processing pipeline. The query processor 216 parses and interprets the user queries and also dynamically refines them to align with the evolving context and knowledge graph. It controls the downstream operations, such as interfacing with the knowledge graph, formulating refined queries, and ensuring a coherent interaction between users and the system. The user query processor 216 performs an efficient encoding and representation fusion to understand the user's intention. Then the query engages with an LLM to generate contextually relevant responses.

Up-to-date information is fetched using real-time knowledge from the knowledge graph and extraction pipeline 200, facilitated by context identifiers. The historical data store is used to fetch sufficient records and to dynamically generate prompts to feed into LLMs to generate responses. This approach ensures that the user query processor 216 is well-equipped to handle diverse user queries, drawing upon real-time and historical data. Post-processing may be applied to refine and optimize responses before they are sent to the user.

A lambda engine 220 is used to support both real-time standing queries and interactive queries in a scalable way, dynamically allocating resources as needed. The lambda engine 220 includes three layers: a batch layer 222, a serving layer 224, and a speed layer 226. The batch layer analyzes batches on historical data, pre-processing and updating the knowledge graph with historical context to provide a foundation for contextual understanding. This result is then infused into the real-time extraction pipeline 200 and knowledge pipeline 210 if needed.

The serving layer 224 provides efficient retrieval of relevant information from the knowledge graph, thereby enhancing the retrieval process for interactive queries. The speed layer 226 ensures that data remains adaptive and responsive to evolving contexts.

Interactive queries, where users seek immediate responses, benefit from the serving layer 224 and the speed layer 226 to obtain quick retrieval and processing of relevant information. Standing queries, which are focused on continuous monitoring and analysis, leverage the batch layer 222 for comprehensive historical context. The three-layered structure helps the lambda engine 220 to balance the demands of historical data processing, real-time query serving, and dynamic stream processing.

In an example of the operation of the lambda engine 220, a query may ask for an analysis of historical traffic patterns on a road segment to identify peak congestion periods. The query may further ask that the result be combined with real-time traffic camera analytics based data to predict and display current congestion layers. Based on this query, the speed layer 226 may query the real-time streaming information for traffic data for the road segment to get a snapshot of current traffic conditions. The batch layer 222 may query a historical materialized view with a longer time frame to identify historical trends. The serving layer 224 may combine the real-time data with the historical data. A response is generated to provide a current congestion level from the real-time data as well as historical trends from the materialized view, allowing for better prediction of future traffic conditions.

The lambda engine 220 may make use of various data sources, including historical data and real-time streaming data. The historical data may include historical traffic patterns in batch storage. For example, such historical data may be stored as camera data analytics. The real-time streaming data may be drawn from sensors such as traffic cameras and internet-of-things (IoT) devices.

The batch layer 222 may periodically process historical data through batch processing frameworks and may perform predetermined analytics, such as identifying historical patterns, performing peak-hour analysis, and identifying weekly and monthly trends. The batch layer 222 may generate and store historical views as materialized views, such as with optimized tables and/or pre-aggregated summaries.

The speed layer 226 may implement real-time analytics pipelines to analyze streaming data in real-time, for example identifying the current status from sensor data. The speed layer 226 can continuously update real-time views in a fast-access datastore. The serving layer 224 may then merge results from the batch layer 222 and the speed layer 226, providing low-latency querying of both historical insights and real-time analytics for downstream services or users.

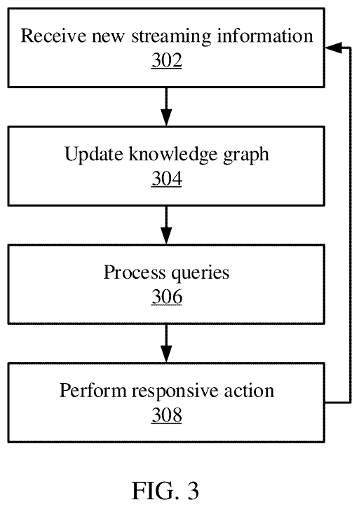

Referring now to FIG. 3, a method for processing streaming information is shown. Block 302 receives new streaming information, such as new frames in a video stream. Block 304 then uses the new streaming information to update the knowledge graph as described above. This may include processing the new frame using one or more VLMs in accordance with available processing resources to extract information relating to, e.g., actions and objects depicted within the new frame.

Based on the updated knowledge graph, block 306 processes queries. Standing queries may be evaluated in view of the updated knowledge graph, to determine whether a new response is needed. Any dynamic and interactive queries that have been received may similarly be processed. Based on the responses to these queries, block 308 performs a responsive action.

For example, if a query identifies that a traffic accident has occurred, block 308 may summon emergency personnel to provide assistance. Block 308 may furthermore send automatic instructions to other vehicles on the road and to traffic control devices to route traffic away from the site of the incident. In a security context, the cameras 102 may monitor a sensitive location and queries may be directed to the detection of unauthorized personnel. In such a context, the responsive action may include summoning security personnel and performing an automatic action with security devices, such as locking or unlocking doors and setting off visual and auditory alarms.

With further attention to the example of tracking traffic information using a video stream, the queries may relate to the identification of traffic conditions (e.g., high traffic or low traffic) or hazardous conditions (e.g., road conditions, accidents, or obstructions). In such a context, an exemplary standing query may be addressed to detecting high traffic, with a responsive action being to change the behavior of a traffic light or road sign to divert traffic to an alternate route. An exemplary dynamic query may identify to the current road condition, such as identifying flooding or snow, and in such a case the action may include instructions to a self-driving vehicle to control its approach to avoid a road hazard.

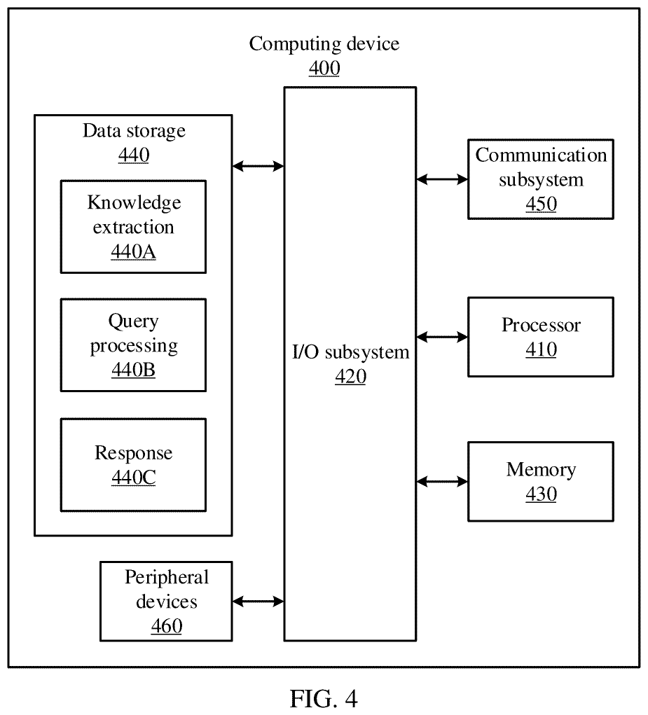

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for knowledge extraction, 440B for processing queries, and/or 440C for performing a responsive action. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

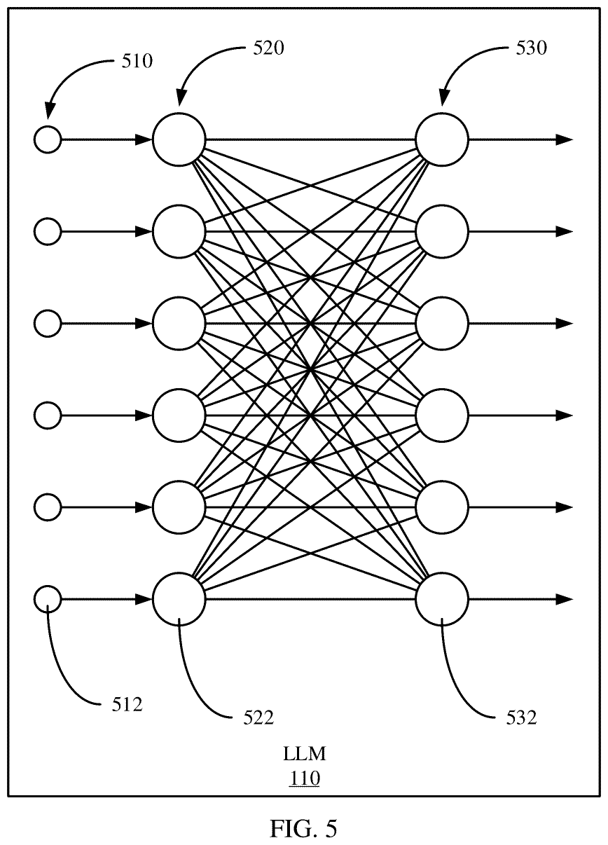

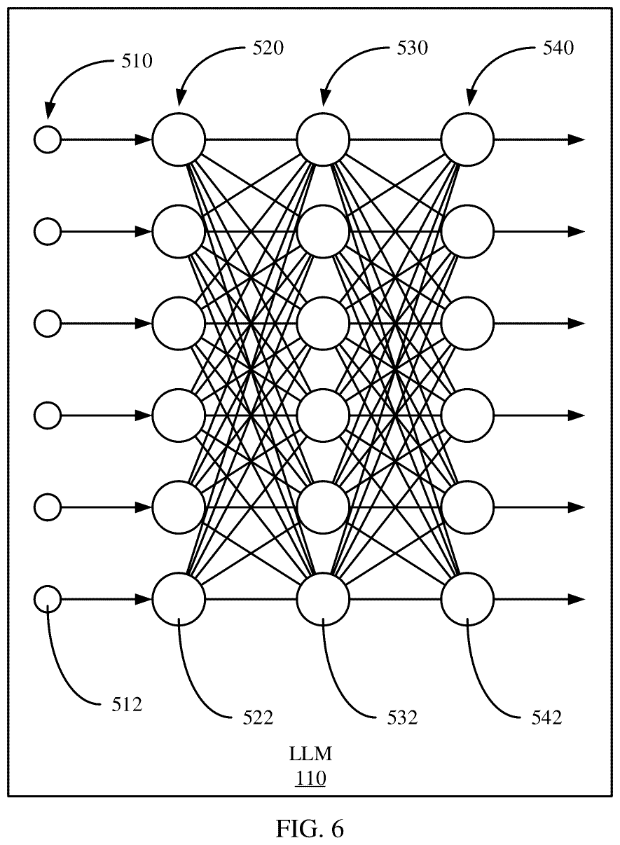

Referring now to FIGS. 5 and 6, exemplary neural network architectures are shown, which may be used to implement parts of the present models, such as the LLM 110. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the

present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for query processing, comprising:
updating a knowledge graph based on information extracted from a streaming information input;
processing one or more queries relating to the streaming information input based on the knowledge graph; and
performing an action responsive to the one-or-more queries.

2. The method of claim 1, wherein updating the knowledge graph includes processing an element of the streaming information input using one or more visual language models (VLMs) to extract context.

3. The method of claim 2, wherein updating the knowledge graph includes extracting metadata that includes spatial information from the streaming information element.

4. The method of claim 2, wherein the one or more VLMs include a lightweight VLM, to answer questions about the streaming information element based on a question bank, and a heavyweight VLM, to correct and adjust responses of the lightweight VLM by updating current context-based questions.

5. The method of claim 1, wherein updating the knowledge graph is performed within a predetermined constraint that is selected from the group consisting of a time limit, a frame-rate target, a latency per frame associated with different VLMs, a predefined maximum latency threshold, and a cost of inference.

6. The method of claim 1, wherein processing the one or more queries uses temporal context to allocate resources, including identifying the one or more queries' specific needs, fetching relevant records from a data store, and prioritizing the fetched records through ranking and filtering via moderation.

7. The method of claim 1, wherein the knowledge graph is represented as subject-predicate-object tuples and is initialized with foundational knowledge based on a task.

8. The method of claim 1, wherein the one or more queries include a standing query and a dynamic query.

9. The method of claim 1, wherein the streaming information includes video of a road scene and wherein the action includes a traffic control action selected from the group consisting of altering behavior of a traffic control device and sending instructions to self-driving vehicles.

10. The method of claim 1, wherein the streaming information includes multivariate streaming data from a plurality of sensors in a facility and wherein the action includes a control action that alters behavior of a system in the facility to resolve an anomalous condition.

11. A system for query processing, comprising:
a hardware processor; and
a memory that stores computer program instructions that, when executed by the hardware processor, cause the hardware processor to:
update a knowledge graph based on information extracted from a streaming information input;
process one or more queries relating to the streaming information input based on the knowledge graph; and
perform an action responsive to the one-or-more queries.

12. The system of claim 11, wherein the update of the knowledge graph includes processing an element of the streaming information input using one or more visual language models (VLMs) to extract context.

13. The system of claim 12, wherein the update of the knowledge graph includes extracting metadata that includes spatial information from the streaming information element.

14. The system of claim 12, wherein the one or more VLMs include a lightweight VLM, to answer questions about the streaming information element based on a question bank, and a heavyweight VLM, to correct and adjust responses of the lightweight VLM by updating current context-based questions.

15. The system of claim 11, wherein the update of the knowledge graph is performed within a predetermined constraint that is selected from the group consisting of a time limit, a frame-rate target, a latency per frame associated with different VLMs, a predefined maximum latency threshold, and a cost of inference.

16. The system of claim 11, wherein the processing of the one or more queries uses temporal context to allocate resources, including identifying the one or more queries' specific needs, fetching relevant records from a data store, and prioritizing the fetched records through ranking and filtering via moderation.

17. The system of claim 11, wherein the knowledge graph is represented as subject-predicate-object tuples and is initialized with foundational knowledge based on a task.

18. The system of claim 11, wherein the one or more queries include a standing query and a dynamic query.

19. The system of claim 11, wherein the streaming information includes video of a road scene and wherein the action includes a traffic control action selected from the group consisting of altering behavior of a traffic control device and sending instructions to self-driving vehicles.

20. The system of claim 11, wherein the streaming information includes multivariate streaming data from a plurality of sensors in a facility and wherein the action includes a control action that alters behavior of a system in the facility to resolve an anomalous condition.
